(19) United States
(12) Patent Application Publication
(10) Pub. No.: US 2026/0024223 A1
(43) Pub. Date: Jan. 22, 2026

(54) ESTIMATION OF A BUILDING AREA USING A SINGLE AERIAL IMAGE

(71) Applicant: LexisNexis Risk Solutions FL Inc., Boca Raton, FL (US)

(72) Inventors: Yiren Ding, Royston, GA (US); Andrew Melkonian, Houston, TX (US); Brian Keller, Columbia, MD (US)

(21) Appl. No.: 18/773,770

(22) Filed: Jul. 16, 2024

(51) Int. Cl. G06T 7/60; G06T 7/50; G06V 10/762; G06V 10/766; G06V 10/774; G06V 20/10; G06V 20/17

(52) U.S. Cl. CPC G06T 7/60; G06T 7/50; G06V 10/762; G06V 10/766; G06V 20/17; G06V 20/176; G06T 2207/10024; G06T 2207/10032; G06T 2207/20081; G06T 2207/30184; G06T 2207/30188; G06V 10/774; G06V 20/188

(57) ABSTRACT

Systems, methods, and non-transitory computer-readable media are disclosed herein for estimating square footage of a building from a single aerial image. The method includes receiving an aerial image of a property; generating, from the aerial image using a trained computer vision model, a predicted Canopy Height Model (CHM_prd); estimating, using the CHM_prd: a height of building-related pixels with respect to corresponding ground-related pixels in the CHM_prd, a number of stories associated with the building, and a footprint corresponding to each story of the building; summing square footage of each story to determine total square footage of the building; and outputting an indication of the total square footage of the building.

### BACKGROUND

Accurate square footage estimates of a physical structure (e.g., a house, room, building, etc.,) can be a major driver for estimating replacement costs. A square footage estimate can also be used to facilitate efficient construction, facilitate maintenance and/or renovation planning, provide documentation for calculating property taxes, etc. However square footage numbers obtained from county records are often inaccurate, outdated, and typically do not represent the ground truth, and the costs to perform manual square foot measurements of properties can be prohibitive.

Various methods for estimating building sizes, roof dimensions, etc., using aerial imagery have been proposed. For example, U.S. Pat. Nos. 8,670,961, 8,818,772, and 10,528,960 require a plurality of aerial images taken from different oblique viewpoints to estimate various geometries such as roof slope, length, and area. U.S. Pat. No. 8,774,525 proposes a system and method for estimating floor area of a building based on roof edge measurements using at least two different orthogonal images having different views. However, the costs associated with obtaining multiple oblique and/or orthogonal images can be significant.

Various methods have been proposed for a user interface that allows a user to interact with building models to extract certain attributes. For example, U.S. Pat. No. 8,825,454, 8,938,090, 9,244,589, and U.S. Patent Application Publication US20190304026 use pre-existing models or utilize a plurality of aerial images taken from different oblique viewpoints to form models that a user may interact with to extract size estimates, etc.

Various methods have been proposed for estimating square footage of walls. For example, U.S. Pat. No. 10,663,294 and U.S. Patent Application Publications 20210232988 and 20230023311 concern the use of preexisting models or models generated using different orthogonal images to estimate wall structure geometries and/or associated replacement costs.

Additional methods have been proposed for estimating the elevation of a first floor. For example, U.S. Pat. No. 11,555,701 utilizes a “digital evaluation map” and a “CNN-based AI engine” to determine an elevation of first floor height.

Certain conventional methods for estimating building size rely on the use of a Digital Surface Model (DSM) to estimate the height of objects. However, the cost of a DSM can be significantly higher than the cost of a single visible-spectrum image.

The traditional systems and methods described in the above referenced patents and published patent applications either do not provide accurate floor-by-floor square foot measurements, or they have additional associated costs, particularly when multiple images, pre-existing models, and/or manual measurements are required for the estimates.

A need exists for improved methods for alternative ways to obtain cost effective and accurate square footage estimates.

### BRIEF SUMMARY

Embodiments of the disclosed technology are directed to systems and methods that utilize a single aerial image normalized to a directly-overhead (i.e., nadir) perspective for determining square footage for each floor of a building. One benefit of this approach is that results in lower costs since visible-spectrum nadir images are less expensive than oblique images, and much less expensive than Digital Surface Models.

A method is disclosed herein for estimating square footage of a building from a single aerial image. The method includes receiving an aerial image of a property; generating, from the aerial image using a trained computer vision model, a predicted Canopy Height Model (CHM_prd); estimating, using the CHM_prd: a height of building-related pixels with respect to corresponding ground-related pixels in the CHM_prd, a number of stories associated with the building, and a footprint corresponding to each story of the building; summing square footage of each story to determine total square footage of the building; and outputting an indication of the total square footage of the building.

Another method is disclosed herein for estimating square footage of a building. The method includes receiving an aerial image of a property; determining, from the aerial image using a computer vision model, non-ground pixels corresponding to one or more of buildings and vegetation; removing, from the aerial image, the non-ground pixels and estimating, using a trained imputation model, a height of each of the non-ground pixels. The method can further include one or more of estimating a height of ground in the aerial image, estimating a height of each building-related pixel with respect to the estimated height of ground, estimating a number of stories for the building, determining square footage of each story using pixel-wise distances, summing the square footage of each story to determine total square footage of the building, and outputting an indication of the total square footage.

A method is proved for estimating a height of observable surfaces in an image. The method can include obtaining an aerial image of a property and a corresponding Digital Surface Model (DSM) representing total heights of terrain and objects of a property; identifying, from the aerial image using a computer vision model, vegetation and building areas in the DSM; removing the identified vegetation and building areas from the DSM; estimating, using a trained imputation model, a Digital Terrain Model (DTM) by imputing height values for areas corresponding to the removed identified vegetation and building areas; and subtracting the estimated DTM from the DSM to derive a height of the observable surfaces with respect to ground.

A method is disclosed for estimating a number of stories in a building. The method can include acquiring a height map of roof surfaces; flattening the height values and creating summary statistics comprising percentile values and an empirical distribution of height using predefined height bins; training a Multivariate Adaptive Regression Splines (MARS) model using the summary statistics to predict the number of stories; and mapping the summary statistics to the number of stories using a trained MARS model.

A system is disclosed that includes a processor, memory in communication with the processor and storing a trained computer vision model and instructions that cause the processor to: receive an aerial image of a property; generate, from the aerial image using the trained computer vision model, a predicted Canopy Height Model (CHM_prd); estimate, using the CHM_prd: a height of building-related pixels with respect to corresponding ground-related pixels in the CHM_prd, a number of stories associated with the building, and a footprint corresponding to each story of the building; sum square footage of each story to determine total square footage of the building; and output an indication of the total square footage of the building.

The disclosed technology includes a non-transitory medium with instructions stored thereon that, when executed by a processor of a computing device, cause the computing device to perform operations including wherein the trained computer vision model is configured to: receiving an aerial image of a property; generating, from the aerial image using a trained computer vision model, a predicted Canopy Height Model (CHM_prd); estimating, using the CHM_prd: a height of building-related pixels with respect to corresponding ground-related pixels in the CHM_prd, a number of stories associated with the building, and a footprint corresponding to each story of the building; summing square footage of each story to determine total square footage of the building; and outputting an indication of the total square footage of the building, wherein the trained computer vision model is configure to determine non-ground pixels in the aerial image corresponding to one or more of buildings and vegetation; generate an estimated Digital Terrain Model (DTM_est) by imputing elevations of ground locations corresponding to each of the non-ground pixels; generate a predicted Canopy Height Model (CHM_prd) from the aerial image based on training the computer vision model with a plurality of Digital Surface Models (DSMs) and a corresponding plurality of aerial images; and generate the CHM_est by a pixel-by-pixel difference between DSM and DTM_est.

The disclosed technology may be understood and implemented with the aid of the following diagrams.

### BRIEF DESCRIPTION OF THE DRAWINGS

FIG. 1A illustrates a side-view representation of a Digital Surface Model (DSM) of a region having sloped terrain and vegetation.

FIG. 1B illustrates a side-view representation of a Digital Terrain Model (DTM) of a region having sloped terrain and vegetation (as shown in FIG. 1A).

FIG. 1C illustrates a side-view representation of a Canopy Height Model (CHM) of a region having sloped terrain and vegetation (as shown in FIGS. 1A and 1B).

FIG. 2A shows an example of an orthographic image with buildings and nearby vegetation.

FIG. 2B shows a 30 cm Digital Surface Model (DSM) corresponding to the image shown in FIG. 2A.

FIG. 3A shows a 30 cm DSM with vegetation and buildings removed, in accordance with certain exemplary implementations of the disclosed technology.

FIG. 3B shows an Inverse Distance Weight (IDS) imputation of the image shown in FIG. 3A, in accordance with certain exemplary implementations of the disclosed technology.

FIG. 4A shows a Canopy Height Model (CHM) image by IDS weighted imputation, in accordance with certain exemplary implementations of the disclosed technology.

FIG. 4B shows an example CHM by XGBoost imputation techniques, in accordance with certain exemplary implementations of the disclosed technology.

FIG. 5A shows an example of an orthographic image with buildings and nearby vegetation.

FIG. 5B shows an image representation of predicted height of the structures in FIG. 5A, in accordance with certain exemplary implementations of the disclosed technology.

FIG. 5C shows an image representation of true height of the structures in FIG. 5A.

FIG. 6 is a block-diagram illustration of the interrelated process of imputation, training, and prediction of a CHM, in accordance with certain exemplary implementations of the disclosed technology.

FIG. 7A is an orthographic image with buildings and nearby vegetation.

FIG. 7B shows an image representation of the image of FIG. 7A with height pixels showing floor footprints, in accordance with certain exemplary implementations of the disclosed technology.

FIG. 7C illustrates a Gaussian Mixture Model (GMM) showing heigh distributions of the height pixels of FIG. 7B.

FIG. 7D illustrates a GMM outline prediction of floors on a two-story house, as shown in FIG. 7A, in accordance with certain exemplary implementations of the disclosed technology.

FIG. 8A is an orthographic image of a building predicted to have three floors.

FIG. 8B shows an image representation of the image of FIG. 8A with height pixels showing floor footprints, in accordance with certain exemplary implementations of the disclosed technology.

FIG. 8C illustrates a Gaussian Mixture Model (GMM) showing heigh distributions of the height pixels of FIG. 8B.

FIG. 8D illustrates a GMM prediction of two floors on the building shown in FIG. 8A, in accordance with certain exemplary implementations of the disclosed technology.

FIG. 9A is an orthographic image of a building predicted to have three floors.

FIG. 9B shows an image representation of the image of FIG. 9A with height pixels showing floor footprints, in accordance with certain exemplary implementations of the disclosed technology.

FIG. 9C illustrates a Gaussian Mixture Model (GMM) showing heigh distributions of the height pixels of FIG. 9B.

FIG. 9D illustrates a GMM outline prediction of a single floor house, as shown in FIG. 9A, in accordance with certain exemplary implementations of the disclosed technology.

FIG. 10 is a block diagram representation of a computing system that can be configured to implement some embodiments of the disclosed technology.

FIG. 11 is a flow diagram of an example method according to embodiments of the presently disclosed technology.

FIG. 12 is a flow diagram of another example method according to embodiments of the presently disclosed technology.

FIG. 13 is a flow diagram of another example method according to embodiments of the presently disclosed technology.

FIG. 14 is a flow diagram of another example method according to embodiments of the presently disclosed technology.

### DETAILED DESCRIPTION

Certain implementations of the disclosed technology can provide an estimate of total square footage of a home from a single image. For example, a first trained model (such as XGBoost) may be utilized to generate an estimated Digital Terrain Model (DTM_est) based on an input Digital Surface Model (DSM), and an estimated Canopy Height Model (CHM_est) can be generated as the difference between the DSM and the DTM_est to estimate ground height via imputation, as will be discussed herein.

In accordance with certain exemplary implementations of the disclosed technology, a second trained computer vision model may output a predicted Canopy Height Model (CHM_pred) based on a single RGB input image. In certain exemplary implementations, the second model may be trained using multiple estimated Canopy Height Models (i.e., using the CHM_est that may be generated using the first model using corresponding multiple DSM) corresponding to the RGB images.

Once trained, the second model may be used to generate a predicted Canopy Height Model (CHM_pred) from a single RGB image, eliminating the need to purchase further DSMs, which can be much more expensive than an RGB image.

In general, a height estimate of all observable surfaces in the RGB image may be made and/or normalized for example, by removing height variation due to land slope and vegetation, for example, using the first trained model. Certain implementations may obtain the height of surfaces on the roof of the building, estimate the number of stories for the building, map roof regions to story level (e.g., first floor region, second floor region), use pixel-wise distances to measure the square footage for each story, and sum the square footage of each story to obtain the total square footage.

Certain implementations of the disclosed technology may be utilized to estimate total square footage of a building even if it is built on land with a fair amount of slope. For example, a house built on a lot with a steep incline may have one story built on a high portion of the land, while the part of the home on the lower portion of the land may have two stories. Without understanding the slope of the land, certain models may estimate that the entire home was only one story, or that the entire home was two stories. Certain implementations of the disclosed technology may utilize slope of the property to determine which parts of the home are one, two, three, etc., stories regardless of the slope of the land.

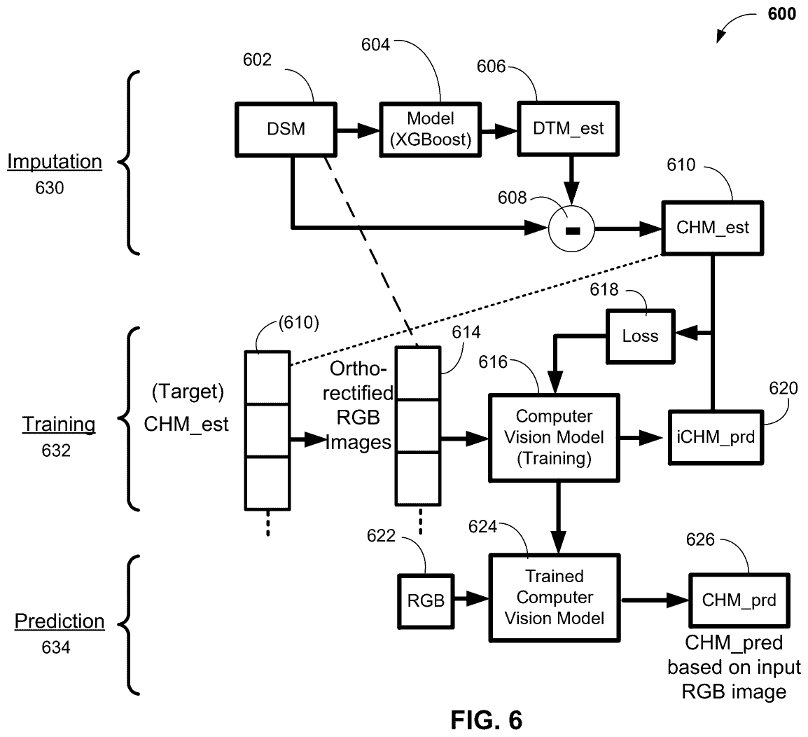

In accordance with certain exemplary implementations of the disclosed technology, and as will be discussed in detail with respect to FIG. 6, an estimated DTM (DTM_est) may be generated by removing the vegetation and buildings from the DSM via a first trained model, then the DTM_est may be subtracted from the DSM to create an estimated CHM (CHM_est), which as will be discussed below, may be utilized to train a second (computer vision) model to produce a predicted CHM (CHM_pred) based on an input RGB image.

In accordance with certain exemplary implementations of the disclosed technology, an orthorectified RGB image may be used to extract building footprints (i.e., the outline of the building) and surrounding vegetation polygons (i.e., outlines of all vegetation). Certain implementations of the disclosed technology will now be explained with the aid of the accompanying figures.

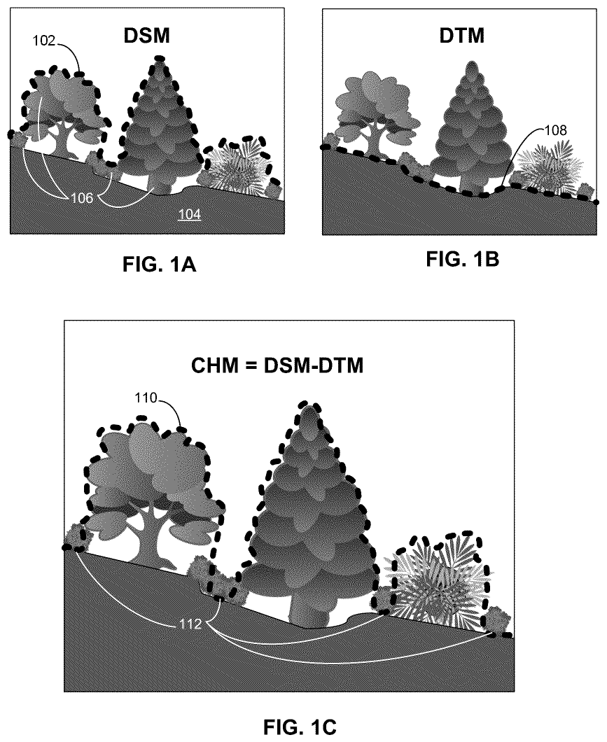

FIG. 1A illustrates a side-view representation of a Digital Surface Model (DSM) 102 of a region having sloped terrain 104 and vegetation 106. The DSM can be considered as an elevation model that captures both the environment's natural and artificial features. A typical DSM can include the tops of buildings, trees, powerlines, other objects, foliage, etc. In a DSM, the true ground height may be represented where there is nothing else above it. In the example illustration of FIG. 1A, the represented area of the DSM has trees and other foliage 106 entirely covering the ground, so the ground level may be unknown and additional models may be needed to determine the actual ground level.

FIG. 1B illustrates a side-view representation of a Digital Terrain Model (DTM) 108 of the region having sloped terrain and vegetation (as shown in FIG. 1A). The DTM (also known as a Digital Elevation Model) is a topographic model of the bare Earth excluding trees, buildings, and any other surface objects. The associated data in the DTM is typically created using methods such as Light Detection and Ranging (LiDAR) or photogrammetry but can require additional processing to remove objects above the ground.

FIG. 1C illustrates a side-view representation of a Canopy Height Model (CHM) 110 of a region having sloped terrain and vegetation (as shown in FIGS. 1A and 1B). The CHM represents the height of objects above the ground, such as trees and buildings, in relation to the ground 112 topography. A CHM may be created by combining high-resolution imagery data with LiDAR data. The CHM can be considered as the difference between a DSM and a DTM, and a CHM may be utilized to determine or estimate the height of building walls above the ground so that, for example, the number of stories may be determined for calculating square footage.

The cost for a DSM and/or a DTM in some cases can be 5× the cost of aerial RGB imagery by itself. Certain implementations of the disclosed technology can reduce data cost per property by estimating the DTM instead of buying it. Certain implementations of the disclosed technology may utilize a method to estimate a CHM (FIG. 1C) without using the DTM (FIG. 1B). For example, the CHM can be estimated (CHM_est) by removing vegetation and buildings from the DSM and imputing the missing pixels, as will now be discussed with reference to the following figures.

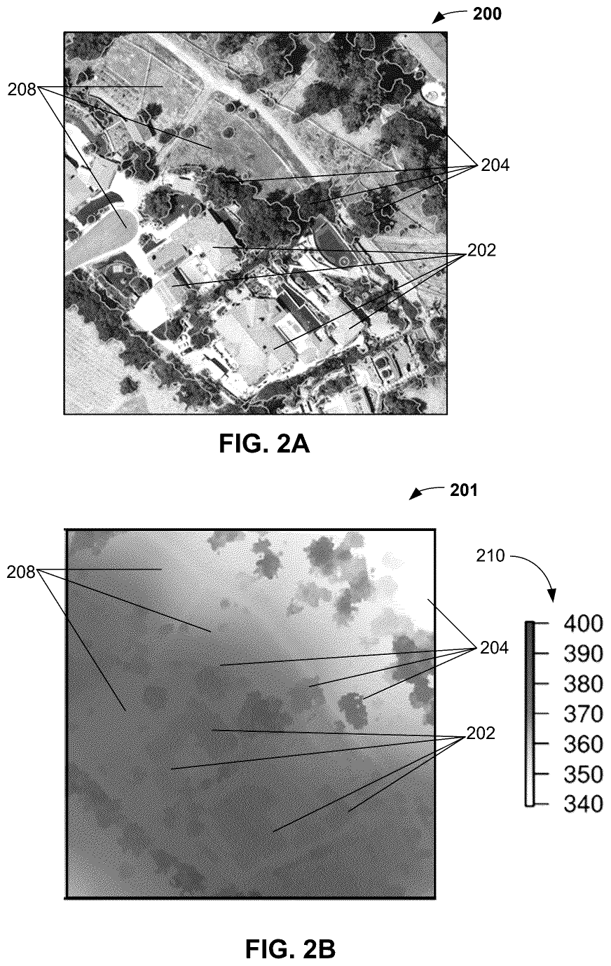

FIG. 2A shows an example of an (aerial) RGB orthographic image 200 with buildings 202 of interest, nearby vegetation 204, and portions of uncovered ground 208. In such images, the buildings 202 and vegetation 204 cover or obscure certain regions of the ground, making it difficult to determine the actual ground height near the walls of the buildings 202, which can make it difficult to estimate the actual height of the buildings 202.

FIG. 2B shows a Digital Surface Model (DSM) 201 corresponding to the image 200 shown in FIG. 2A, with grayscale values representing the height of the buildings 202 of interest, height of nearby vegetation 204, and height of portions of ground 208 not covered by buildings or vegetation. In certain implementations, the height of the objects in the DSM may be represented by a color plot. FIG. 2B also shows height legend 210 (or key) that corresponds to the height of the objects in the DSM.

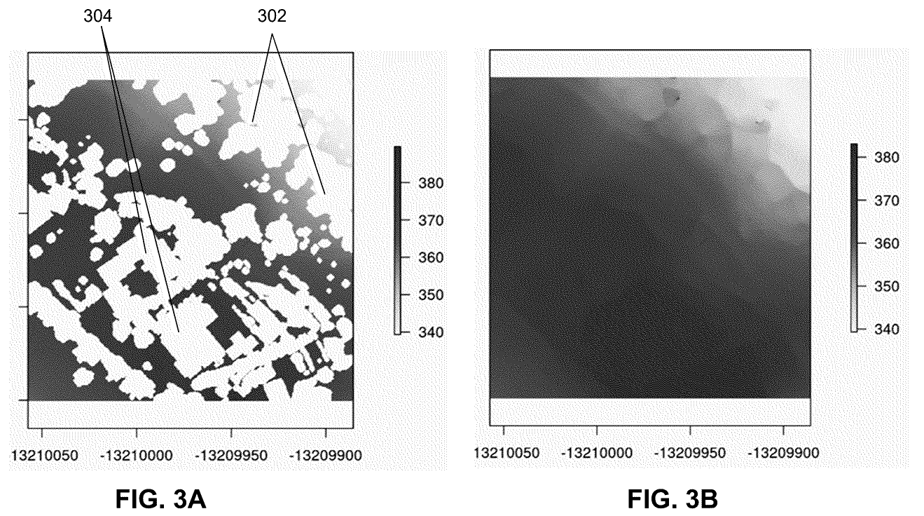

FIG. 3A illustrates a processed DSM in which pixels corresponding to identified vegetation 302 and buildings 304 are removed, in accordance with certain exemplary implementations of the disclosed technology. To remove such pixels (that are shown in FIG. 3A as white areas), and in accordance with certain exemplary implementations of the disclosed technology, one or more computer models may be utilized to extract/remove areas within the boundaries of all buildings 304 and vegetation 302 from the image of interest. In certain implementations, a small dilation of the identified vegetation and/or building footprints may be applied before interpolating the removed pixels (to essentially estimate a DTM, as will be further discussed with reference to FIG. 6 below).

FIG. 3B illustrates an example of an estimated DTM (DTM_est) in which the DSM's removed buildings 304 and vegetation 302 (as illustrated in FIG. 3A) may be imputed from the remaining pixels, or otherwise replaced by interpolation. In certain implementations, an Inverse Distance Weight (IDS) imputation may be utilized. In certain implementations, a model such as XGBoost may be trained and utilized to perform the imputation step(s). In accordance with certain exemplary implementations of the disclosed technology, the values assigned to the pixels corresponding to the areas of the removed buildings 304 and vegetation 302 may be calculated based on a weighted average of the values available at the known (remaining) points. In accordance with certain exemplary implementations of the disclosed technology, only the DSM is needed to train the imputation model that may be used to estimate the height of the ground where the buildings and vegetation are located.

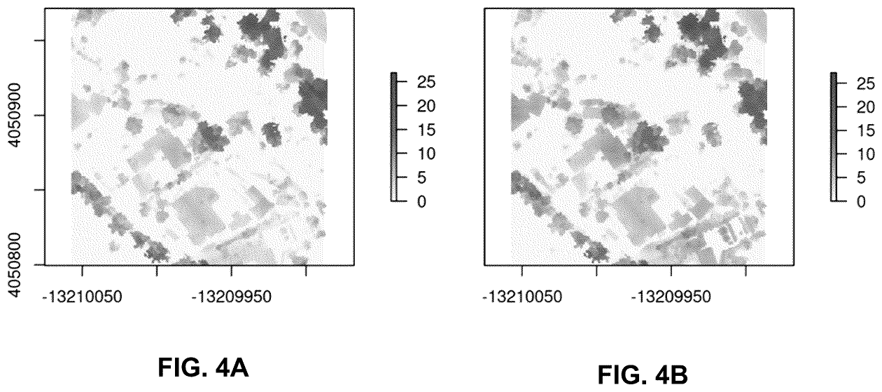

FIG. 4A shows an estimated Canopy Height Model (CHM_est) derived using the Inverse Distance Weight (IDS) imputation, in accordance with certain exemplary implementations of the disclosed technology.

FIG. 4B shows an estimated Canopy Height Model (CHM_ext) derived using the XGBoost model imputation technique, as discussed above, in accordance with certain exemplary implementations of the disclosed technology.

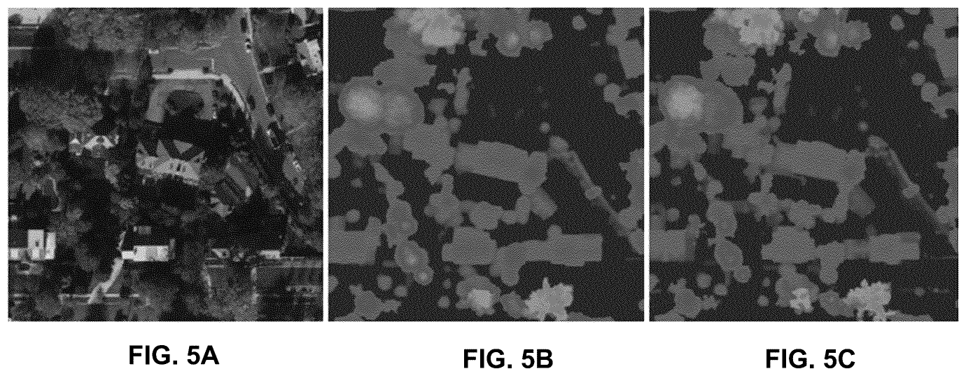

FIG. 5A shows an example representation of an orthographic (RGB) image with buildings and nearby vegetation. FIG. 5B shows an image representation of predicted height of the structures in FIG. 5A, in accordance with certain exemplary implementations of the disclosed technology. FIG. 5C shows an image representation of true height of the structures in FIG. 5A and visually shows the similarity to the predicted height.

The generation and utilization of the various images/models discussed above provide examples of how a predicted Canopy Height Model (CHM_pred) may be generated using a single orthorectified RGB image. Certain details for how this may be accomplished will now be discussed.

FIG. 6 is a block-diagram illustration of the interrelated process 600 of imputation 630, training 632, and prediction 634 of a Canopy Height Model (CHM_pred) 626. As will be shown, certain implementations of the disclosed technology may utilize a single RGB image 622 (such as an aerial image) to produce a CHM_pred 626 by the trained model 624 without requiring an actual DSM or DTM. In general, the interrelated process 600 can include identifying and removing anything in the image that is not ground-specifically the buildings and the vegetation-then the height at all the pixels in the spaces that were removed may be estimated by the imputation process 630. To estimate (or impute) the removed values, a first trained model 604 may be utilized. In certain implementations, an XGBoost model may be trained using DSMs 602 as the ground truth.

Once the first model 604 is trained for imputation, the DSMs 602 are no longer needed to estimate building height. Thus, according to certain implementation, trained models (604 624) enable deriving building height using a single image by removing all non-ground pixels, imputing the height at each of the removed points, then estimating the height for each pixel of the building with respect to the estimated height of the ground.

In certain implementations, the two models 604 624 may be utilized for different processing tasks. For example, in the imputation process 630, a first model 604 may convert a DSM 602 to an estimated CHM (CHM_est) 610 by first estimating a DTM (DTM_est) 606 by a pixel-by-pixel subtraction 608. For example, CHM_est=DSM−DTM_est.

In accordance with certain implementations of the disclosed technology, the first model 604 (XGBoost or otherwise) may be trained for imputation using many locations to provide a diverse spectrum of property characteristics. In certain implementations, DSMs 602 from hundreds of locations to several thousand locations may be used for the training of the first model 604. In certain implementations, ortho-rectified RGB images 614 corresponding to the DSMs 602 may be obtained and used for the training phase 632, as will be explained below. As previously discussed, since a DSM can be much more expensive than a corresponding RGB image, there may be an up-front investment cost in obtaining the diverse set of DSMs to train the first model 604 (and corresponding RGBs 614 to train the second model 616. But once the first model 604 is trained for the imputation 630 and generation of the DTM_est 606 using the diverse set of DSMs, there may be no further need to purchase DSMs.

In accordance with certain exemplary implementations of the disclosed technology, a segmentation model with a ConvNeXt backbone and a U-net architecture may be used to predict the height for every pixel in the image. In certain implementations, the loss 618 may utilize Monocular Depth Estimation-the weighted sum of the structural similarity index (SSIM), L1-loss, and the depth smoothness loss-to measure the distance between predicted height and the true height.

In accordance with certain exemplary implementations of the disclosed technology, a training phase 632 may be utilized to train the second model 616 using multiple target CHM_est 610 (as generated in the imputation phase 630) along with corresponding multiple ortho-rectified RGB images 614 corresponding to the DSMs 602 used to train the first model 604. In certain implementations, the second model 616 may be refined, in part, by utilizing a loss 618 between the intermediate predicted Canopy Height Model (ICHM_prd) 620 and the CHM_est 610 output in the imputation process 630.

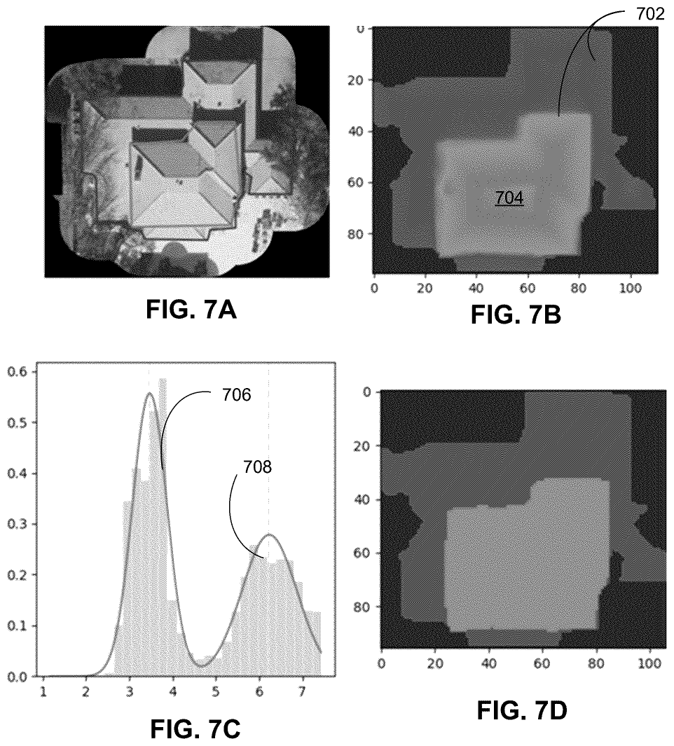

In the prediction step 630, and in accordance with certain exemplary implementations, a single RGB image 622 may be input to the trained second model 624 to produce a predicted Canopy Height Model (CHM_prd) 626, which may then be utilized to estimate the square footage of a building, as will be discussed further below with reference to FIGS. 7A-9D. Therefore, certain implementations of the disclosed technology may utilize a single RGB image 622 (such as an aerial image) to produce a CHM_prd 626 by the trained model 624 without requiring an actual DSM or DTM. For example, an image of shape (256, 256, 3) may be input to the trained (computer vision) second model 624, which may output the CHM_prd 626 in the form of a height map of (256, 256), which shows the height of each pixel in the input image. After the model 624 is trained, only an RGB image is needed to estimate the height for a given location without requiring a DSM and/or DTM.

FIGS. 7A-9D will now be discussed to illustrate how the CHM_prd 626 may be further analyzed and/or processed to estimate height of a building relative to ground, determine the outline of each story of the building, and estimate the total square footage of the building.

FIG. 7A is an orthographic (RGB) image with buildings and nearby vegetation. In certain implementations, this image may be input to the trained computer vision model 624 to produce the CHM_prd image of FIG. 7B, which is an image representation of the image of FIG. 7A with height pixels showing floor footprints 702 including the roof pitch 704, in accordance with certain exemplary implementations of the disclosed technology.

FIG. 7C illustrates post processing results using a Gaussian Mixture Model (GMM) showing heigh distributions 706 708 of the height pixels of FIG. 7B. FIG. 7D illustrates a GMM outline prediction of floors on a two-story house, as shown in FIG. 7A, in accordance with certain exemplary implementations of the disclosed technology.

In accordance with certain exemplary implementations of the disclosed technology, publicly available information may be obtained (for example from Zillow and/or Street View imagery) to label the number of stories (1, 1.5, 2, 2.5, 3, 3.5, etc.) for a set of residential buildings. In certain implementations, for each building, the height values may be flattened and certain summary statistics may be generated, including the percentile values and the empirical distribution of the height using bins 0-1 m, 1-2 m, 2-3 m, . . . , and 9-10 m. In certain implementations, a Multivariate Adaptive Regression Splines (MARS) model may be trained with degree 1 to map the summary statistics to the number of floors.

In accordance with certain exemplary implementations of the disclosed technology, using the predicted number of stories (N) as integers between 1-3 and height map of the roof, N Gaussian mixture models may be fit with up to N components (cluster centers). In addition, a model may be excluded if the distance between two adjacent components is less than 1.5 meters. In certain implementations, the best Gaussian Mixture Model (GMM) may be selected by the one with the lowest Bayes Information Criterion (BIC).

Returning to example of a 2-story building as shown in FIG. 7A, FIG. 7C indicates that GMM identifies two height distributions, the first distribution 708 centered at 3.5 m and a second distribution 708 centered at 6.2 m. Since 3.5 m and 6.2 m are sufficiently far apart, the pixel height that are close to 6.2 m (determined by GMM) may be classified as the second floor, and the pixels that are close to 3.5 m may be classified as first floor. FIG. 7D illustrates the GMM pixel classification for this example. Since the height map is often occluded by vegetation, the building footprint may be used as the first-floor polygon. In certain implementations, OpenCV may be used to find the contours of the higher floors.

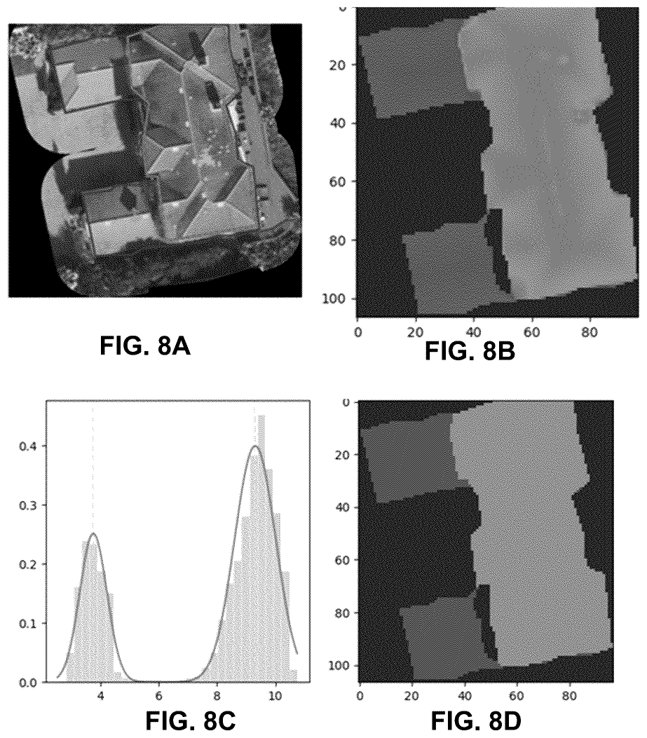

FIG. 8A depicts another example of an orthographic image of a building predicted to have three floors. FIG. 8B shows an image representation of the image of FIG. 8A with height pixels showing floor footprints, in accordance with certain exemplary implementations of the disclosed technology. FIG. 8C illustrates the GMM showing heigh distributions of the height pixels of FIG. 8B. FIG. 8D illustrates a GMM prediction of two floors for the building shown in FIG. 8A. In this example, the disclosed technology provides a method for determining the actual number of floors, despite an inaccurate initial prediction of the number of floors.

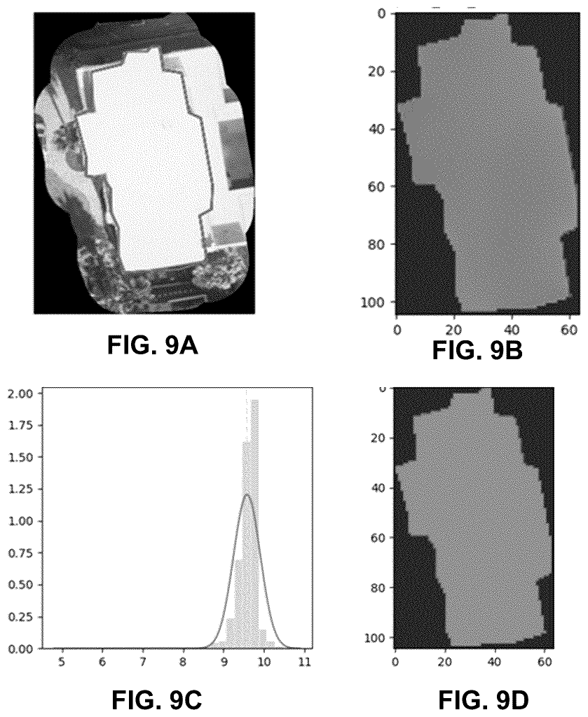

FIG. 9A is another orthographic image of a building predicted to have three floors. FIG. 9B shows an image representation of the image of FIG. 9A with height pixels showing floor footprints, in accordance with certain exemplary implementations of the disclosed technology. FIG. 9C illustrates a GMM showing heigh distributions of the height pixels of FIG. 9B. FIG. 9D illustrates a GMM outline prediction of a single floor house, as shown in FIG. 9A, in accordance with certain exemplary implementations of the disclosed technology. Again, in this example, the disclosed technology enables determining the actual number of floors, despite an inaccurate initial prediction of the number of floors.

In accordance with certain exemplary implementations of the disclosed technology, if the GMM gives a smaller number of cluster centers than the predicted number of floors, a set of rules may be utilized to classify the floor footprints accordingly. For example, let S denote the predicted number of stories and let G denote the number of clusters from GMM. Certain implementations may utilize the following rules:

If S=2 and G=1, both first and second floor will be equal to the building footprint.

If S>=3 and G=2, the top GMM contour will be both second and third floor (as indicated in FIGS. 8A-8D).

If S>=3 and G=1, the first, second, and third floor will all be equal (as indicated in FIGS. 9A-9D).

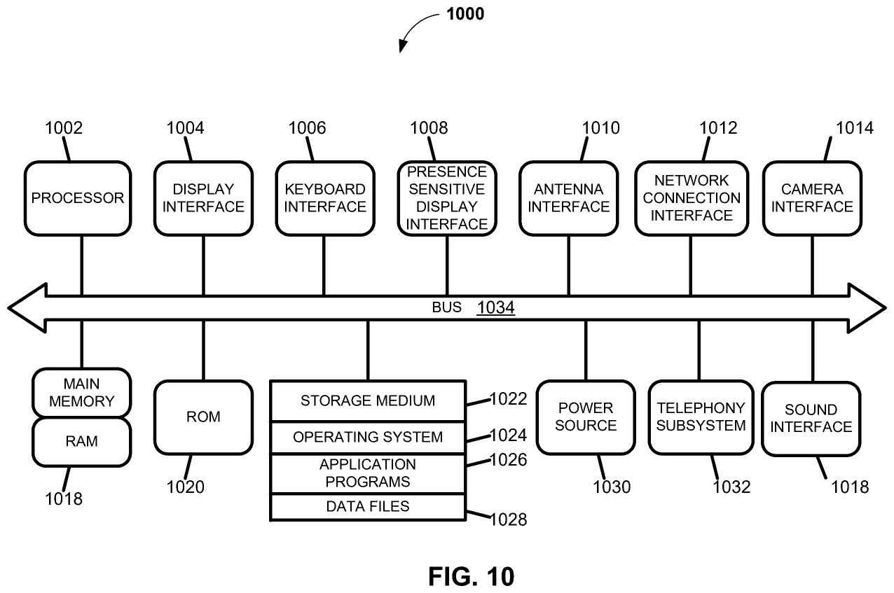

FIG. 10 is a block diagram representation of a computing system that can be configured to implement some embodiments of the disclosed technology. FIG. 10 depicts a block diagram of an illustrative computing device 1000 that may be utilized to enable certain aspects of the disclosed technology. Various implementations and methods herein may be embodied in non-transitory computer-readable media for execution by a processor. It will be understood that the computing device 1000 is provided for example purposes only and does not limit the scope of the various implementations of the communication systems and methods.

The computing device 1000 of FIG. 10 includes one or more processors where computer instructions are processed. The computing device 1000 may comprise the processor 1002, or it may be combined with one or more additional components shown in FIG. 10. In some instances, a computing device may be a processor, controller, or central processing unit (CPU). In yet other instances, a computing device may be a set of hardware components.

The computing device 1000 may include a display interface 1004 that acts as a communication interface and provides functions for rendering video, graphics, images, and texts on the display. In certain example implementations of the disclosed technology, the display interface 1004 may be directly connected to a local display. In another example implementation, the display interface 1004 may be configured for providing data, images, and other information for an external/remote display. In certain example implementations, the display interface 1004 may wirelessly communicate, for example, via a Wi-Fi channel or other available network connection interface 1012 to the external/remote display.

In an example implementation, the network connection interface 1012 may be configured as a communication interface and may provide functions for rendering video, graphics, images, text, other information, or any combination thereof on the display. In one example, a communication interface may include a serial port, a parallel port, a general-purpose input and output (GPIO) port, a game port, a universal serial bus (USB), a micro-USB port, a high-definition multimedia (HDMI) port, a video port, an audio port, a Bluetooth port, a near-field communication (NFC) port, another like communication interface, or any combination thereof. In one example, the display interface 1004 may be operatively coupled to a local display. In another example, the display interface 1004 may wirelessly communicate, for example, via the network connection interface 1012 such as a Wi-Fi transceiver to the external/remote display.

The computing device 1000 may include a keyboard interface 1006 that provides a communication interface to a keyboard. According to certain example implementations of the disclosed technology, the presence-sensitive display interface 1008 may provide a communication interface to various devices such as a pointing device, a touch screen, etc.

The computing device 1000 may be configured to use an input device via one or more of the input/output interfaces (for example, the keyboard interface 1006, the display interface 1004, the presence-sensitive display interface 1008, the network connection interface 1012, camera interface 1014, sound interface 1016, etc.,) to allow a user to capture information into the computing device 1000. The input device may include a mouse, a trackball, a directional pad, a trackpad, a touch-verified trackpad, a presence-sensitive trackpad, a presence-sensitive display, a scroll wheel, a digital camera, a digital video camera, a web camera, a microphone, a sensor, a smartcard, and the like. Additionally, the input device may be integrated with the computing device 1000 or may be a separate device. For example, the input device may be an accelerometer, a magnetometer, a digital camera, a microphone, and an optical sensor.

Example implementations of the computing device 1000 may include an antenna interface 1010 that provides a communication interface to an antenna; a network connection interface 1012 that provides a communication interface to a network. According to certain example implementations, the antenna interface 1010 may utilize to communicate with a Bluetooth transceiver.

In certain implementations, a camera interface 1014 may be provided that acts as a communication interface and provides functions for capturing digital images from a camera. In certain implementations, a sound interface 1016 is provided as a communication interface for converting sound into electrical signals using a microphone and for converting electrical signals into sound using a speaker. According to example implementations, random-access memory (RAM) 1018 is provided, where computer instructions and data may be stored in a volatile memory device for processing by the CPU 1002.

According to an example implementation, the computing device 1000 includes a read-only memory (ROM) 1020 where invariant low-level system code or data for basic system functions such as basic input and output (I/O), startup, or reception of keystrokes from a keyboard are stored in a non-volatile memory device. According to an example implementation, the computing device 1000 includes a storage medium 1022 or other suitable types of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 1024, application programs 1026 (including, for example, a web browser application, a widget or gadget engine, and or other applications, as necessary) and data files 1028 are stored. According to an example implementation, the computing device 1000 includes a power source 1030 that provides an appropriate alternating current (AC) or direct current (DC) to power components. According to an example implementation, the computing device 1000 includes a telephony subsystem 1032 that allows the device 1000 to transmit and receive sound over a telephone network. The constituent devices and the CPU 1002 communicate with each other over a bus 1034.

In accordance with an example implementation, the CPU 1002 has an appropriate structure to be a computer processor. In one arrangement, the computer CPU 1002 may include more than one processing unit. The RAM 1018 interfaces with the computer bus 1034 to provide quick RAM storage to the CPU 1002 during the execution of software programs such as the operating system application programs, and device drivers. More specifically, the CPU 1002 loads computer-executable process steps from the storage medium 1022 or other media into a field of the RAM 1018 to execute software programs. Data may be stored in the RAM 1018, where the data may be accessed by the computer CPU 1002 during execution. In one example configuration, the device 1000 includes at least 128 MB of RAM, and 256 MB of flash memory.

The storage medium 1022 itself may include a number of physical drive units, such as a redundant array of independent disks (RAID), a floppy disk drive, a flash memory, a USB flash drive, an external hard disk drive, a thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer-readable storage media allow the device 1000 to access computer-executable process steps, application programs, and the like, stored on removable and non-removable memory media, to off-load data from the device 1000 or to upload data onto the device 1000. A computer program product, such as one utilizing a communication system may be tangibly embodied in storage medium 1022, which may comprise a machine-readable storage medium.

According to one example implementation, the term computing device, as used herein, may be a CPU, or conceptualized as a CPU (for example, the CPU 1002 of FIG. 10). In this example implementation, the computing device (CPU) may be coupled, connected, and/or in communication with one or more peripheral devices.

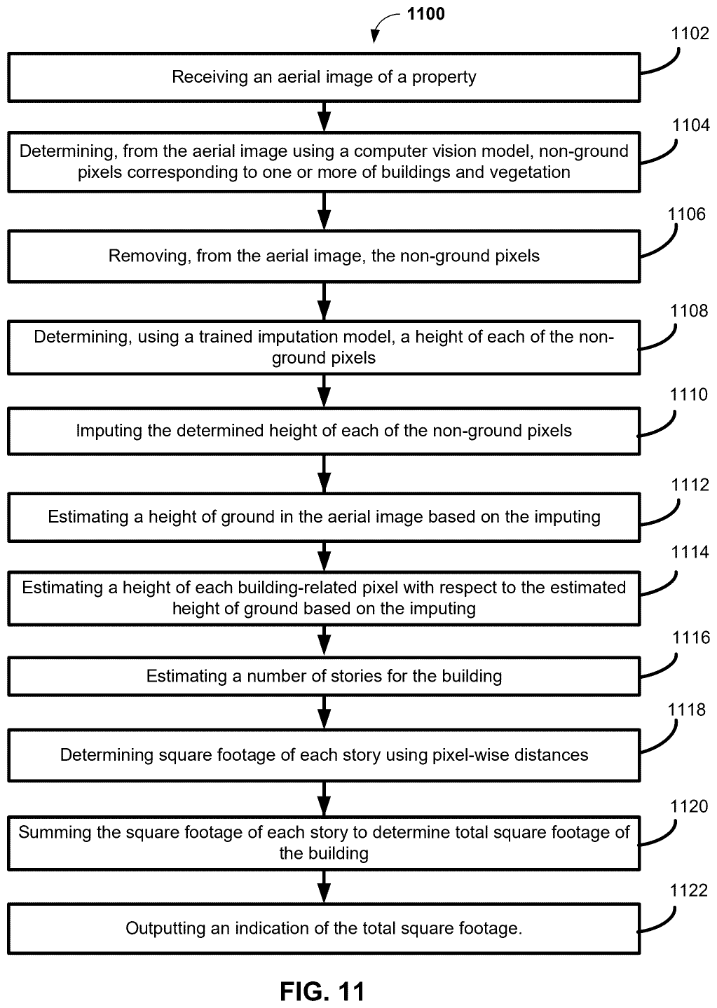

FIG. 11 is a flow diagram of an example method for estimating square footage of a building. In block 1102, the method 1100 includes receiving an aerial image of a property. In block 1104, the method 1100 includes determining, from the aerial image using a computer vision model, non-ground pixels corresponding to one or more of buildings and vegetation. In block 1106, the method 1100 includes removing, from the aerial image, the non-ground pixels. In block 1108, the method 1100 includes determining, using a trained imputation model, a height of each of the non-ground pixels. In block 1110, the method 1100 includes imputing the determined height of each of the non-ground pixels. In block 1112, the method 1100 includes estimating a height of ground in the aerial image based on the imputing. In block 1114, the method 1100 includes estimating a height of each building-related pixel with respect to the estimated height of ground based on the imputing. In block 1116, the method 1100 includes estimating a number of stories for the building. In block 1118, the method 1100 includes determining square footage of each story using pixel-wise distances. In block 1120, the method 1100 includes summing the square footage of each story to determine total square footage of the building. In block 1122, the method 1100 includes outputting an indication of the total square footage.

Certain implementations of the disclosed technology may further include mapping roof regions to corresponding story levels for the building.

Certain implementations of the disclosed technology include training the imputation model based on a plurality of Digital Surface Models (DSM). Certain implementations of the disclosed technology include estimating a Canopy Height Model (CHM) of the property based at least in part on the imputing and the estimated height of the ground. In certain implementations, estimating the CHM can include utilizing Inverse Distance Weighted (IDW) and/or Extreme Gradient Boosting (XGB) imputation.

In certain implementations, estimating the height of each building-related pixel is performed without using a Digital Terrain Model (DTM) or a Digital Surface Model (DSM).

In accordance with certain exemplary implementations of the disclosed technology, the trained imputation model may be trained using a plurality of properties.

Certain implementations of the disclosed technology can include fitting N Gaussian Mixture Models (GMM) to the estimated a height of each building-related pixel to determine 0-N height clusters. In certain implementations, the GMM with the lowest Bayes Information Criterion (BIC) may be selected to determine the number of stories in a building. In certain implementations, a GMM may be excluded if a distance between two adjacent clusters is less than 1.5 meters.

Certain implementations of the disclosed technology include using OpenCV to determine contours of one or more stories of the building.

Certain implementations of the disclosed technology can include using a set of rules to classify floor footprints when the selected GMM predicts a fewer number of height clusters centers than the estimated number of stories for the building.

Certain implementations of the disclosed technology include training a Multivariate Adaptive Regression Splines (MARS) model to map summary statistics to estimate the number of stories, wherein estimating the number of stories for the building is based on an output of the MARS model. In some implementations, the MARS model may be trained using a set of labeled residential buildings with stories classified as 1, 1.5, 2, 2.5, 3, and 3.5.

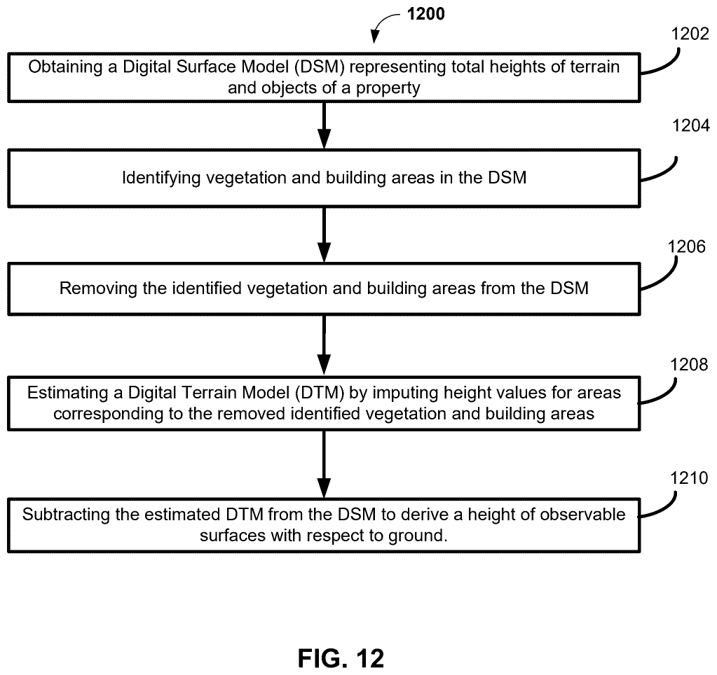

FIG. 12 is a flow diagram of another example method for estimating a height of observable surfaces in an image. In block 1202, the method 1200 includes obtaining a Digital Surface Model (DSM) representing total heights of terrain and objects of a property. In block 1204, the method 1200 includes identifying vegetation and building areas in the DSM. In block 1206, the method 1200 includes removing the identified vegetation and building areas from the DSM. In block 1208, the method 1200 includes estimating a Digital Terrain Model (DTM) by imputing height values for areas corresponding to the removed identified vegetation and building areas. In block 1210, the method 1200 includes subtracting the estimated DTM from the DSM to derive the height of observable surfaces with respect to ground.

Certain implementations of the disclosed technology can include normalizing the derived height of the observable surfaces by detecting and accounting for variations in land slope using slope analysis, and removing height variations due to vegetation by identifying and excluding height anomalies corresponding to vegetation.

Certain implementations of the disclosed technology include estimating a number of stories for a building in the image, determining square footage of each story using pixel-wise distances, summing the square footage of each story to determine total square footage of the building, and outputting an indication of the total square footage.

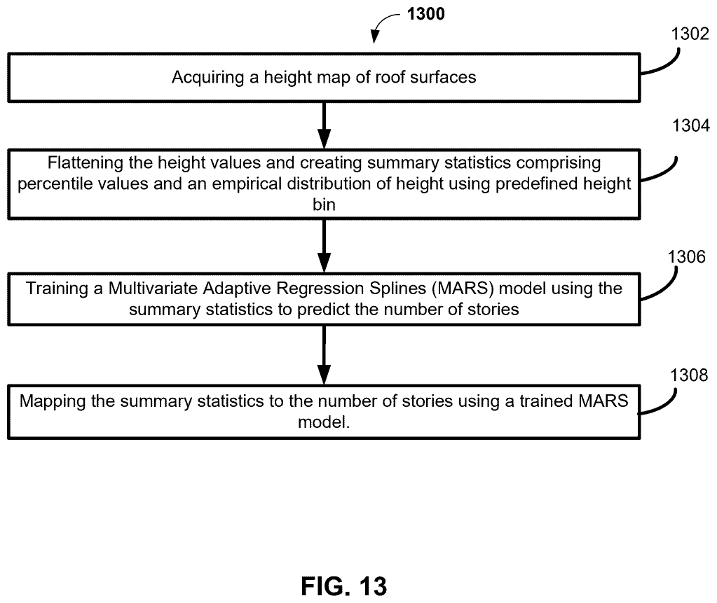

FIG. 13 is a flow diagram of an example method for estimating a number of stories in a building. In block 1302, the method 1300 includes acquiring a height map of roof surfaces. In block 1304, the method 1300 includes flattening the height values and creating summary statistics comprising percentile values and an empirical distribution of height using predefined height bins. In block 1306, the method 1300 includes training a Multivariate Adaptive Regression Splines (MARS) model using the summary statistics to predict the number of stories. In block 1308, the method 1300 includes mapping the summary statistics to the number of stories using a trained MARS model.

In certain implementations, the MARS model may be trained on a dataset of residential buildings with labeled stories. In certain implementations, the labeled stories comprise 1, 1.5, 2, 2.5, 3, and 3.5 stories.

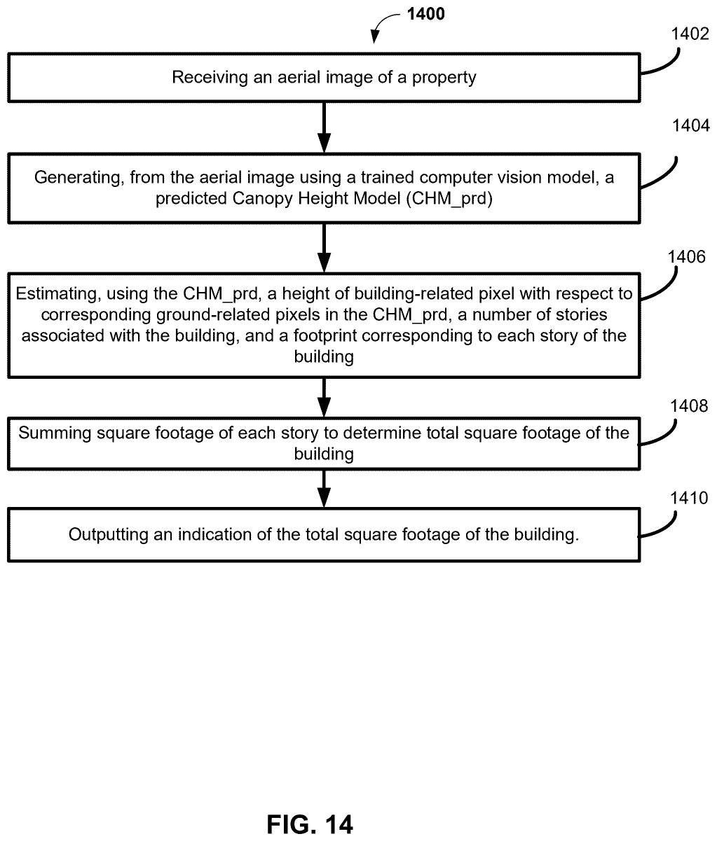

FIG. 14 is a flow diagram of an example method for estimating square footage of a building from a single aerial image. In block 1402, the method 1400 includes receiving an aerial image of a property. In block 1404, the method 1400 includes generating, from the aerial image using a trained computer vision model, a predicted Canopy Height Model (CHM_prd). In block 1406, the method 1400 includes estimating, using the CHM_prd, a height of building-related pixels with respect to corresponding ground-related pixels in the CHM_prd, a number of stories associated with the building, and a footprint corresponding to each story of the building. In block 1408, the method 1400 includes summing square footage of each story to determine total square footage of the building. In block 1410, the method 1400 includes outputting an indication of the total square footage of the building.

In accordance with certain exemplary implementations of the disclosed technology, the trained computer vision model may be configured to perform one or more of the following: determine non-ground pixels in the aerial image corresponding to one or more of buildings and vegetation; generate an estimated Digital Terrain Model (DTM_est) by imputing elevations of ground locations corresponding to each of the non-ground pixels; generate a predicted Canopy Height Model (CHM_prd) from the aerial image based on training the computer vision model with a plurality of Digital Surface Models (DSMs) and a corresponding plurality of aerial images; and generate the CHM_est by a pixel-by-pixel difference between DSM and DTM_est.

In certain implementations, the corresponding plurality of aerial images can include RGB images. In certain implementations, the corresponding plurality of aerial images can include orthorectified images. In certain implementations, the corresponding plurality of aerial images can include orthorectified RGB images.

In certain implementations, generating the CHM_prd can include utilizing one or more of Inverse Distance Weighted (IDW) imputation and Extreme Gradient Boosting (XGB) imputation.

In accordance with certain exemplary implementations of the disclosed technology, the height of each building-related pixel may be estimated without requiring a Digital Terrain Model (DTM). In accordance with certain exemplary implementations of the disclosed technology, the height of each building-related pixel may be estimated without requiring a Digital Surface Model (DSM).

In certain implementations, estimating the number of stories associated with the building can include fitting N Gaussian Mixture Models (GMM) to the estimated a height of each building-related pixel to determine 0-N height clusters. Certain implementations can include selecting the GMM with a lowest Bayes Information Criterion (BIC) and estimating the number of stories based on a number of associated height clusters. In certain implementations, a GMM may be excluded if a distance between two adjacent clusters is less than 1.5 meters.

Certain implementations of the disclosed technology can include using a set of rules to classify floor footprints when the selected GMM predicts a fewer number of height clusters centers than an estimated number of stories for the building. In certain implementations, the rules may utilize S to denote the estimated number of stories and G to denote a number of determined height clusters from the selected GMM; wherein: if S=2 and G=1, both a first and a second floor will be equal to a building footprint; if S>=3 and G=2, a top GMM contour will represent both the second floor and a third floor; and if S>=3 and G=1, the first floor, the second floor, and the third floor will have equivalent footprints.

Certain implementations of the disclosed technology include training a Multivariate Adaptive Regression Splines (MARS) model to map summary statistics to estimate the number of stories. In certain implementations, the number of stories for the building may be based on an output of the MARS model.

In certain implementations, the MARS model may be trained using a set of labeled residential buildings with stories classified as 1, 1.5, 2, 2.5, 3, and 3.5.

In accordance with certain exemplary implementations of the disclosed technology, the estimating of the height of each building-related pixel with respect to adjacent ground-related pixels can include normalizing derived heights of observable surfaces by detecting and accounting for variations in land slope using slope analysis and removing height variations due to vegetation by identifying and excluding height anomalies corresponding to vegetation.

Implementations of the subject matter and the functional operations described herein can be implemented in various systems, digital electronic circuitry, or in computer software, firmware, or hardware, including the structures, disclosed in this specification and their structural equivalents, or in combinations of one or more of them. Implementations of the subject matter described herein can be implemented as one or more computer program products, i.e., one or more modules of computer program instructions encoded on a tangible and non-transitory computer-readable medium for execution by, or to control the operation of a data processing apparatus. The computer-readable medium can be a machine-readable storage device, a machine-readable storage substrate, a memory device, a composition of matter affecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other units suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory, or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media, and memory devices, including by way of example semiconductor memory devices, e.g., EPROM, EEPROM, and flash memory devices. The processor and the memory can be supplemented by, or incorporated into, special-purpose logic circuitry.

While this disclosure contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described herein, and other implementations, enhancements, and variations can be made based on what is described herein and illustrated in the accompanying figures.

What is claimed:

1. A method for estimating square footage of a building from a single aerial image, comprising:
receiving an aerial image of a property;
generating, from the aerial image using a trained computer vision model, a predicted Canopy Height Model (CHM_prd);
estimating, using the CHM_prd:
a height of building-related pixels with respect to corresponding ground-related pixels in the CHM_prd;
a number of stories associated with the building; and
a footprint corresponding to each story of the building;
summing square footage of each story to determine total square footage of the building; and
outputting an indication of the total square footage of the building.

2. The method of claim 1, wherein the trained computer vision model is configured to:
determine non-ground pixels in the aerial image corresponding to one or more of buildings and vegetation;
generate an estimated Digital Terrain Model (DTM_est) by imputing elevations of ground locations corresponding to each of the non-ground pixels;
generate a predicted Canopy Height Model (CHM_prd) from the aerial image based on training the computer vision model with a plurality of Digital Surface Models (DSMs) and a corresponding plurality of aerial images; and
generate the CHM_est by a pixel-by-pixel difference between DSM and DTM_est.

3. The method of claim 2, wherein the corresponding plurality of aerial images comprises orthorectified RGB images.

4. The method of claim 1, wherein generating the CHM_prd comprises utilizing one or more of Inverse Distance Weighted (IDW) imputation and Extreme Gradient Boosting (XGB) imputation.

5. The method of claim 1, wherein the height of each building-related pixel is estimated without requiring a Digital Terrain Model (DTM) or a Digital Surface Model (DSM).

6. The method of claim 1, wherein estimating the number of stories associated with the building comprises:
fitting N Gaussian Mixture Models (GMM) to the estimated a height of each building-related pixel to determine 0-N height clusters; and
selecting the GMM with a lowest Bayes Information Criterion (BIC) and estimating the number of stories based on a number of associated height clusters.

7. The method of claim 6, wherein a GMM is excluded if a distance between two adjacent clusters is less than 1.5 meters.

8. The method of claim 6, further comprising using a set of rules to classify floor footprints when the selected GMM predicts a fewer number of height clusters centers than an estimated number of stories for the building.

9. The method of claim 8, wherein S denote the estimated number of stories and G denotes a number of determined height clusters from the selected GMM; wherein:
if S=2 and G=1, both a first and a second floor will be equal to a building footprint;
if S>=3 and G=2, a top GMM contour will represent both the second floor and a third floor; and
if S>=3 and G=1, the first floor, the second floor, and the third floor will have equivalent footprints.

10. The method of claim 1, further comprising training a Multivariate Adaptive Regression Splines (MARS) model to map summary statistics to estimate the number of stories, wherein estimating the number of stories for the building is based on an output of the MARS model.

11. The method of claim 10, wherein the MARS model is trained using a set of labeled residential buildings with stories classified as 1, 1.5, 2, 2.5, 3, and 3.5.

12. The method of claim 1, wherein estimating the height of each building-related pixel with respect to adjacent ground-related pixels comprising normalizing derived heights of observable surfaces by:
detecting and accounting for variations in land slope using slope analysis; and
removing height variations due to vegetation by identifying and excluding height anomalies corresponding to vegetation.

13. A system, comprising:
a processor,
memory in communication with the processor and storing a trained computer vision model and instructions that cause the processor to:
receive an aerial image of a property;
generate, from the aerial image using the trained computer vision model, a predicted Canopy Height Model (CHM_prd);
estimate, using the CHM_prd:
a height of building-related pixels with respect to corresponding ground-related pixels in the CHM_prd;
a number of stories associated with the building; and
a footprint corresponding to each story of the building;
sum square footage of each story to determine total square footage of the building; and
output an indication of the total square footage of the building.

14. The system of claim 13, wherein the trained computer vision model is configured to:
determine non-ground pixels in the aerial image corresponding to one or more of buildings and vegetation;
generate an estimated Digital Terrain Model (DTM_est) by imputing elevations of ground locations corresponding to each of the non-ground pixels;
generate an estimated Digital Surface Model (DSM_est) from the aerial image based on training the computer vision model with a plurality of Digital Surface Models (DSMs) and a corresponding plurality of aerial images; and
generate the CHM_prd by a pixel-by-pixel difference between the DSM_est and the DTM_est.

15. The system of claim 13, wherein CHM_prd is generated utilizing one or more of Inverse Distance Weighted (IDW) imputation and Extreme Gradient Boosting (XGB) imputation.

16. The system of claim 13, wherein the height of each building-related pixel is estimated without requiring a Digital Terrain Model (DTM) or a Digital Surface Model (DSM).

17. The system of claim 13, wherein the number of stories associated with the building is estimated by:
fitting N Gaussian Mixture Models (GMM) to the estimated a height of each building-related pixel to determine 0-N height clusters; and
selecting the GMM with a lowest Bayes Information Criterion (BIC) and estimating the number of stories based on a number of associated height clusters.

18. The system of claim 17, wherein the instructions further cause the processor to classify floor footprints using rules when the selected GMM predicts a fewer number of height clusters centers than an estimated number of stories for the building.

19. The system of claim 18, wherein rules utilize S to denote the estimated number of stories and G to denote a number of determined height clusters from the selected GMM; wherein:
if S=2 and G=1, both a first and a second floor will be equal to a building footprint;
if S>=3 and G=2, a top GMM contour will represent both the second floor and a third floor; and
if S>=3 and G=1, the first floor, the second floor, and the third floor will have equivalent footprints.

20. A non-transitory computer-readable medium with instructions stored thereon that, when executed by a processor of a computing device, cause the computing device to perform operations comprising:
receiving an aerial image of a property;
generating, from the aerial image using a trained computer vision model, a predicted Canopy Height Model (CHM_prd);
estimating, using the CHM_prd:
a height of building-related pixels with respect to corresponding ground-related pixels in the CHM_prd;
a number of stories associated with the building; and
a footprint corresponding to each story of the building;
summing square footage of each story to determine total square footage of the building; and
outputting an indication of the total square footage of the building;
wherein the trained computer vision model is configured to:
determine non-ground pixels in the aerial image corresponding to one or more of buildings and vegetation;
generate an estimated Digital Terrain Model (DTM_est) by imputing elevations of ground locations corresponding to the non-ground pixels;
generate a predicted Canopy Height Model (CHM_prd) from the aerial image based on training the computer vision model with a plurality of Digital Surface Models (DSMs) and a corresponding plurality of aerial images; and
generate the CHM_est by a pixel-by-pixel difference between DSM and DTM_est.
